(19) United States
(12) Patent Application Publication
(10) Pub. No.: US 2018/0364048 A1
(43) Pub. Date: Dec. 20, 2018

(54) METHODS, ARCHITECTURES, APPARATUSES, SYSTEMS DIRECTED TO DEVICE POSITION TRACKING

(71) Applicant: IDHL Holdings, Inc., Wilmington, DE (US)

(72) Inventors: Bryan A. Cook, Silver Spring, MD (US); Zhanlue Zhao, Boyds, MD (US)

(21) Appl. No.: 16/012,078

(22) Filed: Jun. 19, 2018

Related U.S. Application Data
(60) Provisional application No. 62/522,600, filed on Jun. 20, 2017.

(51) Int. Cl. G01C 21/16

(52) U.S. Cl. CPC G01C 21/16; G06F 3/0346

(57) ABSTRACT

Methods, architectures, apparatuses, systems, devices, and computer program products directed to device position tracking are provided. Device position tracking may rely on maintaining frame alignment between tracking-system and tracked-device frames. Performing frame alignment may include determining an alignment transformation that may (e.g., best) align a linear position measured at a tracking system with a linear acceleration measured at a tracked device. The alignment transformation may be applied to align the linear position and any signal in the device frame, such as any of angular velocity, angular acceleration, angular position, gravity, linear velocity, linear position or magnetometer in the device frame. Once aligned, the linear position and such signal in the device frame may be combined.

### RELATED APPLICATIONS

This application claims the benefit of U.S. Provisional Application No. 62/522,600, filed Jun. 20, 2017, which is incorporated herein by reference.

### BACKGROUND

The present invention is directed to the fields of communications, motion measurement and tracking, software and any combinations thereof, and embodiments include methods, architectures, apparatuses, systems directed to device position tracking. Such device position tracking may be carried out, for example, in any of augmented reality (AR), virtual reality (VR), mixed reality (MR), computer-generated imagery (CGI), combined CGI and real-world imagery, and like type environments and/or systems. The device position tracking may be carried out in, and/or in connection with, other various environments and/or systems, including tracking of robotic devices, vehicles, people or things in motion, etc.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures and the detailed description are not to be considered limiting, and other equally effective examples are possible and likely. Furthermore, like reference numerals (“ref. ”) in the Figures indicate like elements, and wherein:

FIGS. 1A-1B are block diagrams illustrating representative systems in which one or more embodiments may be implemented;

FIGS. 2A-2B are a block diagram illustrating various frames of reference (“frames”) that may be associated with the systems of FIGS. 1A-1B;

FIG. 3 is a block diagram illustrating a representative procedure directed to frame aligning of linear position and linear acceleration of a tracked device;

FIG. 4 is a block diagram illustrating a representative procedure directed to frame aligning of linear position and angular position of a tracked device;

FIG. 5 illustrates a first representative usage scenario for the representative system of FIG. 1 using the corresponding reference frames of FIG. 2A;

FIG. 6 illustrates a second representative usage scenario for the representative system of FIG. 1 using the corresponding reference frames of FIG. 2;

FIG. 7 illustrates a third representative usage scenario for the representative system of FIG. 1 using the corresponding reference frames of FIG. 2.

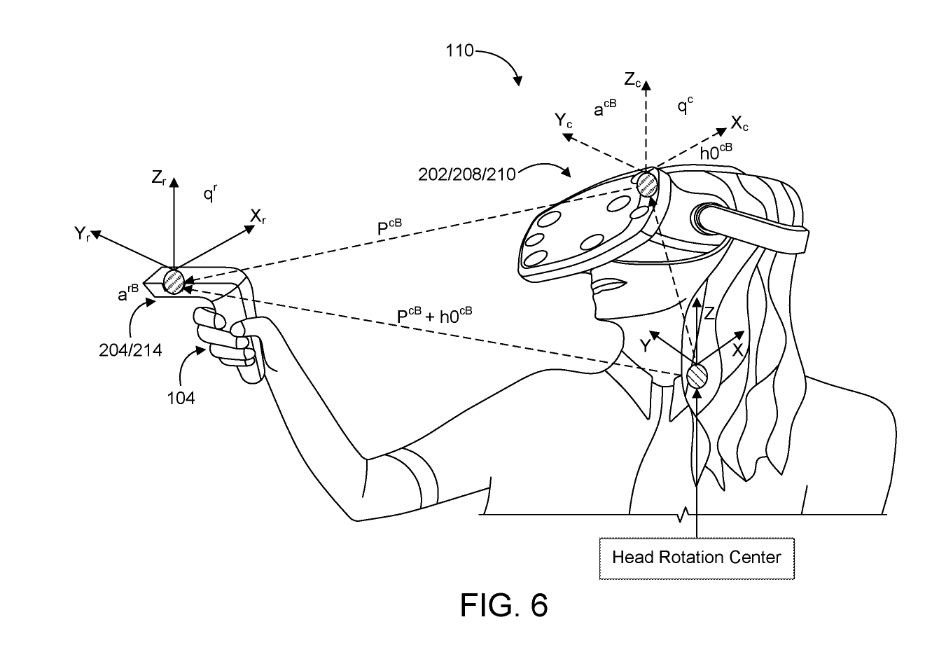

FIG. 8 illustrates relative motion of points on a rigid body according to an embodiment; and

FIG. 9 illustrates representative DC-block filter frequency responses according to an embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein.

Introduction

As used herein, the term “position” may refer to linear position, angular position, or a combination of both linear position and angular position. Pose is a common industry term for a combination of linear position and angular position. Linear position may refer to a location that may be defined by any number of methods including a three-dimensional (3D) vector of Cartesian coordinates, a 3D vector of spherical coordinates, etc. Angular position may refer to a 3D orientation that may be defined by any number of methods including Euler angles, direction cosine matrix, quaternion, vector/angle, Pauli spin matrix, direction+normal vector, etc. In the description that follows, angular position may be expressed in terms of quaternion. Those skilled in the art will recognize that other definitions of angular position are (e.g., equally) applicable to some or all of the disclosure and various disclosed embodiments described in connection with angular position in terms of quaternion, and can be modified accordingly without undue experimentation.

To track a device with six (6) degrees-of-freedom (DOF), linear and angular positions of the device may be used. In some architectures, a tracking system (e.g., a camera or other sensor system) may measure the linear position, and the angular position may be measured using an inertial measurement unit (IMU) disposed in the tracked device. Aligning a device frame associated with the tracked device (e.g., a sensor frame measured by, and/or derived from measurements from, the IMU) and a tracking-system frame associated with the tracking system allows the two measurements to be integrated in a meaningful way. Because the alignment between the device and tracking-system frames may change over time due to various errors, including IMU drift, etc., performing tracking of the alignment between the device and tracking-system frames on a continuous, continual or occasional basis may be warranted.

In some architectures, the tracking system may be able to estimate an angular position of the tracked device independently. In some of those architectures, the tracked device may include an IMU. The IMU may be included, for example, to improve accuracy or responsiveness of the device. The device frame and the tracking-system frames may be aligned using the two angular position estimates. In some other architectures, the tracking system (e.g., a camera tracking a single marker, such as an illuminated ball, on the device) might not be able to estimate the angular position of the tracked device independently. The IMU of the tracked device may be the only source to provide a measurement of the angular position.

Pursuant to the methodologies and technologies disclosed herein, tracking of the frame alignment between the device and tracking-system frames may be carried out in various system architectures, including, for example, architectures that support the IMU of the tracked device as a source (e.g., sole source) for providing the measurement of angular position. The frame alignment may be carried out by finding or otherwise determining an alignment transformation (e.g., rotation, scale, skew, translation and/or perspective projection) that can (e.g., best) align the linear position measured by the tracking system with the linear acceleration measured using the IMU of the tracked device. A number of preprocessing transformations may be used to robustly correlate these two measurements. The preprocessing transformations may include any of time integrals and/or derivatives; appropriate filtering e.g., to remove noise and/or prevent buildup of integration errors); application of the rigid-body equation to compensate for the geometry of what is tracked (e.g., the position offset between the point tracked by linear position and the (e.g., accelerometer of the) IMU), etc. Pursuant to the methodologies and technologies disclosed herein, applying the preprocessing transformations and robustly computing the alignment transformation along with optimization formulations may be carried out to (e.g., efficiently) compute the frame alignment.

Overview

As would be appreciated by a person of skill in the art based on the teachings herein, encompassed within the embodiments described herein, without limitation, are procedures, methods, architectures, apparatuses, systems, devices, and computer program products directed to estimating linear position and linear acceleration (or angular position) of a device (“tracked device”) tracked by a tracking system. In an embodiment, the linear acceleration (or angular position) measured locally at the tracked device and the linear position of the tracked device measured remotely at the tracking system are aligned. The aligned linear acceleration (or angular position) and linear positions may be fused in a common frame (common to both tracked device and tracking system frames).

In an embodiment, a method directed to frame aligning of a linear position and a linear acceleration (or angular position) of a tracked device may include any of the following: obtaining the linear acceleration (or angular position) in a first frame associated to the tracked device; obtaining the linear position in a second frame associated to a tracking device; transforming the linear acceleration (or angular position) and the linear position into one of first and second position signals, first and second velocity signals and first and second acceleration signals defining change in position, change in velocity and change in acceleration, respectively; determining a transform for aligning the first and second frames based on the one of first and second position signals, first and second velocity signals and first and second acceleration signals; and aligning the linear position and linear acceleration (or angular position) using the transform.

In an embodiment, the transform may be any of a rotation transformation, a linear position transformation, a yaw only rotation transformation, a pitch and roll only transformation, a scale transformation, a skew transformation, a perspective projection transformation and a non-linearity transformation.

In an embodiment, determining the transform may include any of solving a Wahba's problem formulation for the first and second position signals, the first and second velocity signals or the first and second acceleration signals; using a linear fitting model problem formulation for the first and second position signals, the first and second velocity signals or the first and second acceleration signals; using a non-linear optimization search for the first and second position signals, the first and second velocity signals or the first and second acceleration signals; and using any search that finds a “best” rotation that minimizes a cost function representing an error between the first and second position signals, the first and second velocity signals or the first and second acceleration signals.

In an embodiment, the transform may be applied to align the linear position and any inertial measurements available from an IMU of the tracked device, including any of angular velocity, angular acceleration, angular position, gravity, linear acceleration, linear velocity, linear position or magnetometer.

In an embodiment, the first frame may be any of an Earth frame, a user frame, a level frame and an arbitrary, short term common frame. In an embodiment, the second frame may be any of an Earth frame, a user frame, a level frame and an arbitrary, short term common frame. In an embodiment, both of the first and second frames are associated with a tracking center of the tracked device.

In an embodiment, transforming the linear acceleration and the linear position into first and second position signals may include any of performing a time integration of the linear acceleration to obtain a velocity signal, performing a time integration of the velocity signal to obtain a position signal and filtering the position using one or more filters that retain signal variation; and filtering the linear position using the one or more filters.

In an embodiment, transforming the linear acceleration and the linear position into first and second velocity signals may include any of performing a time integration of the linear acceleration to obtain a first velocity signal and filtering the first velocity signal using one or more filters that retain signal variation; and performing a time derivative of the linear position to obtain a second velocity signal and filtering the second velocity signal using the one or more filters.

In an embodiment, transforming the linear acceleration and the linear position into first and second acceleration signals may include any of performing a time derivative of the linear position to obtain a velocity signal, performing a time derivative of the velocity signal to obtain an acceleration signal and filtering the acceleration signal using one or more filters that retain signal variation; and filtering the linear acceleration using the one or more filters.

In an embodiment, a method may include any of obtaining a linear acceleration of a device in a common reference frame based on inertial measurement data associated with the device; obtaining a linear position of the device in the common reference frame based on measurement data associated with a tracking system that is tracking the device; determining a first filtered linear position of the device in the common reference frame based on signal variation filtered from the linear acceleration using a filter that retains signal variation; determining a second filtered linear position of the device in the common reference frame based on filtering the linear position using the same filter; determining, based on the first and second filtered linear positions, a transformation for aligning a device frame associated with the device and a tracking-system frame associated with the tracking system; transforming any of the device frame and the tracking-system frame based on (e.g., using) the determined transformation; and tracking frame alignment between the device frame and the tracking-system frame based on the transformation.

In an embodiment, determining the first filtered linear position may include applying the filter to the linear acceleration prior to integrating the linear acceleration over time. In an embodiment, determining the second filtered linear position may include applying the filter to the linear position contemporaneous with carrying out the integration of the linear acceleration. In an embodiment, determining the first filtered linear position may include applying the filter to the linear velocity resulting from integration of the linear acceleration prior to integrating the resulting linear velocity over time. In an embodiment, determining the second filtered linear position may include applying the filter to the linear position contemporaneous with carrying out integration of the resulting linear velocity.

In an embodiment, a method may include any of obtaining a linear acceleration of a device in a common reference frame based on inertial measurement data associated with the device; obtaining a linear position of the device in the common reference frame based on measurement data associated with a tracking system that is tracking the device; determining a first filtered linear velocity of the device in the common reference frame based on signal variation filtered from the linear acceleration using a filter that retains signal variation; determining a second filtered linear velocity of the device in the common reference frame based on signal variation filtered from the linear position using the same filter; determining, based on the first and second filtered linear velocities, a transformation for aligning a device frame associated with the device and a tracking-system frame associated with the tracking system; transforming any of the device frame and the tracking-system frame based on the determined transformation; and tracking frame alignment between the device frame and the tracking-system frame based on the transformation.

In an embodiment, determining the first filtered linear velocity may include applying the filter to the linear acceleration prior to integrating the linear acceleration over time. In an embodiment, determining the second filtered linear velocity may include applying the filter to the linear position prior to taking a derivative of the linear position.

In an embodiment, a method may include any of obtaining a linear acceleration of a device in a common reference frame based on inertial measurement data associated with the device; obtaining a linear position of the device in the common reference frame based on measurement data associated with a tracking system that is tracking the device; determining a first filtered linear acceleration of the device in the common reference frame based on filtering the linear acceleration using a filter that retains signal variation; determining a second filtered linear acceleration of the device in the common reference frame based on signal variation filtered from the linear position using the same filter; determining, based on the first and second filtered linear accelerations, a transformation for aligning a device frame associated with the device and a tracking-system frame associated with the tracking system; transforming any of the device frame and the tracking-system frame based on (e.g., using) the determined transformation; and tracking frame alignment between the device frame and the tracking-system frame based on the transformation.

In an embodiment, determining the second filtered linear acceleration may include applying the filter to the linear position prior to taking a derivative of the linear position. In an embodiment, determining the first filtered linear acceleration may include applying the filter to the linear acceleration contemporaneous with carrying out the derivative of the linear position. In an embodiment, determining the second filtered linear acceleration may include applying the filter to the linear velocity resulting from taking the derivative of the linear position prior to taking the derivative of the resulting linear velocity. In an embodiment, determining the first filtered linear acceleration may include applying the filter to the linear acceleration contemporaneous with carrying out the derivative of the resulting linear velocity.

In an embodiment, the transformation may be any of a rotation transformation, a linear transformation, a yaw only rotation transformation, a scale transformation, a skew transformation, and a non-linearity transformation. In an embodiment, determining the transformation may be based on any of a solving a Wahba problem formulation, using a linear fitting model problem formulation using a non-linear optimization search, and any search that finds a “best” rotation that minimizes a cost function representing the error between the first and second filtered linear positions. In an embodiment, the common reference frame may be any of an Earth frame, a user frame, a level frame and an arbitrary frame.

In an embodiment, the method may further include any of receiving or otherwise obtaining inertial measurement data that defines the device frame and includes the linear acceleration associated with the tracked device; receiving or otherwise obtaining measurement data from the tracking system, wherein the measurement data includes the linear position of the tracked device relative to the tracking system frame; determining an angular position of the device in a common reference frame by rotating the device frame to the common reference frame using the inertial measurement data; and removing effects of gravity from the an angular position of the device in the common reference frame.

In an embodiment, the device frame might not be aligned with a sensor frame associated with an IMU from which the inertial measurement data is obtained, and the method may further include any pf determining a displacement between the device frame and the sensor frame; and adjusting the device frame based on the determined displacement.

In an embodiment, the device frame might not be aligned with a tracking point used to track the device, and the method may further include any of determining a displacement between the device frame and the tracking point; and adjusting the device frame based on the determined displacement.

In an embodiment, the tracking-system frame might not be aligned with a second sensor frame associated with an IMU disposed in and/or on a second device associated with the tracking system, and the method may further include any of determining a displacement between tracking-system frame and the second sensor frame; and adjusting the tracking-system frame based on the determined displacement.

In an embodiment, a linear acceleration associated with the second device might not be available, and the method may further include any of selecting a rotation center for the second device; determining a displacement between the rotation center and an origin of the tracking-system frame; and adjusting the tracking-system frame based on the determined displacement.

In an embodiment, the tracking-system frame might not be aligned with the second sensor frame and the device frame might not be aligned with the sensor frame, and the method may further include any of applying a rigid body equation to convert the linear acceleration provided from the device IMU to that of a tracking center of the tracking system; determining an estimated displacement between a tracking center on the device and the device IMU; and converting the acceleration of the device IMU to an acceleration at the tracking center through the rigid body equation.

Pursuant to the methodologies and technologies provided herein, a tracking system frame and the tracked device frame may be aligned without the need of magnetometer or user tares for virtual reality (VR) and/or augmented reality (AR) systems with both outside-in and inside-out tracking. These methodologies and technologies in real system exhibit good performance, robustness and are computationally efficient.

For simplicity of exposition, various disclosed embodiments herein supra and infra are described as utilizing a particular common reference frame, namely, an Earth frame. Those skilled in the art will recognize that a common reference frame other than the Earth frame may be utilized and some or all of the disclosure and various disclosed embodiments can be modified accordingly without undue experimentation. Examples of the common reference frame may include a user frame, a level frame and an arbitrary frame.

Representative System Architectures

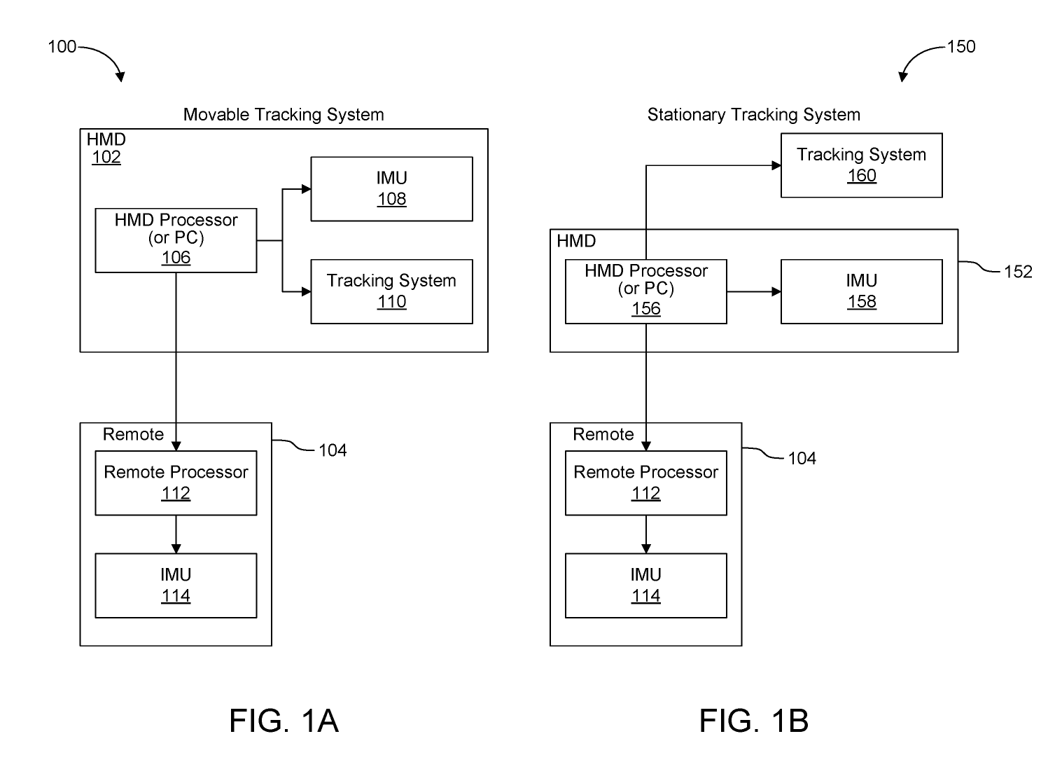

FIG. 1A is a block diagram illustrating a representative system 100 in which one or more embodiments may be implemented. The system 100 may include a head mounted device (HMD) 102 along with a device 104 remotely located from the HMD 102. The device 104 may move independently (e.g., is independently positionable and/or repositionable) from the HMD 102. The device 104 (also referred herein to as “remote 104”) may be tracked with 6 DOF or more than 6 DOF.

The HMD 102 may be configured to provide to a user any of an augmented reality (AR), virtual reality (VR), mixed reality (MR), computer-generated imagery (CGI) and combined CGI and real-world imagery (collectively “adapted reality”) experience via a display disposed in or on an inner portion of the HMD 102. The remote 104 may appear as one or more objects, e.g., a sword, a gun, a baseball bat, a racket, etc., displayed on the display or otherwise used in connection with the adapted reality experience.

The HMD 102 may include a processor 106 communicatively coupled with an IMU 108 and a tracking system 110. The HMD IMU 108 may include an accelerometer and a gyroscope. Alternatively, the HMD IMU 108 may include a magnetometer in addition to an accelerometer and a gyroscope. The accelerometer, gyroscope and magnetometer may be, for example, a three-axis accelerometer, a three-axis gyroscope and a three-axis magnetometer, respectively. The HMD IMU 108 may output inertial measurements (“HMD inertial measurements”) corresponding to, and/or derived from, measurements made by, any of the accelerometer, gyroscope and magnetometer. The HMD inertial measurements may include, for example, linear acceleration and angular velocity measurements corresponding to, and/or derived from, measurements made by, the accelerometer and gyroscope, respectively. The HMD inertial measurements may also include an angular position or estimate of angular position (collectively “angular position”) of the HMD 102. Alternatively, the angular position (“HMD angular position”) of the HMD 102 may be determined by the processor 106 using the HMD inertial measurements received from the HMD IMU 108. In an embodiment, the HMD angular position may be derived from fusion of linear acceleration and angular velocity measurements.

The tracking system 110 may be configured to track the remote 104, and to output tracking-system measurement data associated therewith. The tracking-system measurement data may include, for example, a three-dimensional (3D) linear position of the remotes 104.

The tracking system 110 may include one or more cameras and/or a sensor system configured to use any of various tracking signals to carry out the tracking of the remote 104. The tracking system 110 may be mounted or otherwise disposed in or on the HMD 102 so as to allow for transmission and/or reception of the tracking signals via an outward facing portion (the front) of the HMD 102. The tracking signals may be radio frequency signals, electromagnetic signals, acoustic (including ultrasonic) signals, lasers, any combination thereof, and the like. Tracking of remote 104 carried out using the architecture of the system 100 may be referred to herein as “inside-out” tracking. The tracking system 110 may track only a single point (tracking center) on the remote 104A.

The remote 104 may include a processor 112 communicatively coupled with an IMU 114. The remote IMU 114 may include an accelerometer and a gyroscope. Alternatively, the remote IMU 114 may include a magnetometer in addition to an accelerometer and a gyroscope. The accelerometer, gyroscope and magnetometer may be, for example, a three-axis accelerometer, a three-axis gyroscope and a three-axis magnetometer, respectively. The remote IMU 114 may output inertial measurements (“remote inertial measurements”) corresponding to, and/or derived from, measurements made by, any of the accelerometer, gyroscope and magnetometer. The remote inertial measurements may include, for example, linear acceleration and angular velocity measurements corresponding to, and/or derived from, measurements made by, the accelerometer and gyroscope, respectively, of the remote IMU 114. The remote inertial measurements may also include an angular position of the remote 104. Alternatively, the angular position of the remote 104 may be determined by the processors 112 using the remote inertial measurements received from the remote IMU 114. In an embodiment, the remote angular position may be derived from fusion of linear acceleration and angular velocity measurements.

Although only one trackable device is shown in FIG. 1A, the system 100 may include one or more additional trackable devices akin to the trackable device 104. Each of the additional trackable devices may move independently from one another and/or from the trackable device 104. Alternatively, some (e.g., not all) of the additional trackable devices 104 may move independently from one another and some (e.g., not all) of the additional trackable devices may move independently from the trackable device 104. As used herein, the term “tracked device” may denote active tracking of the device (remote), whereas the term “trackable device” may denote that tracking of a device (remote) is not currently active.

FIG. 1B is a block diagram illustrating another representative system 150 in which one or more embodiments may be implemented. The system 150 of FIG. 1B is similar to the system 100 of FIG. 1A, except that the system 150 may include an HMD 152 communicatively coupled to, and remotely located from a tracking system 160. The HMD 152 may include a processor 156 communicatively coupled with an IMU 158. The processor 156 is akin to the processor 106 (FIG. 1A) and the HMD IMU 158 is akin to the HMD IMU 108 (FIG. 1A).

The tracking system 160 may be mounted stationary in an environment in which the HMD 152 and remote 104 are operating. Alternately, the tracking system 160 may be move independently (e.g., be independently positionable and/or repositionable) in the environment in which the HMD 152 and remote 104 are operating.

The tracking system 160 may be configured to track the HMD 152 and the remote 104, and may output tracking-system measurement data associated therewith. The tracking-system measurement data may include, for example, a three-dimensional (3D) linear position of each of the HMD 152 and remote 104 The tracking system 110 may include one or more cameras and/or a sensor system configured to use any of various tracking signals to carry out the tracking of the HMD 152 and remote 104. The tracking signals may be radio frequency signals, electromagnetic signals, acoustic (including ultrasonic) signals, lasers, any combination thereof, and the like. Tracking of the HMD 152 and remote 104 carried out using the architecture of the system 150 may be referred to herein as “outside-in” tracking. The tracking system 160 may track only a single point (tracking center) on each of the HMD 152 and remote 104.

Further details of an IMU, which may be representative of any of the HMD IMUs 158, 108 and the remote IMUs 114, may be found in application Ser. No. 12/424,090, filed on Apr. 15, 2009; application Ser. No. 11/820,517, filed on Jun. 20, 2007, application Ser. No. 11/640,677, filed Dec. 18, 2006 and which issued on Aug. 28, 2007 as U.S. Pat. No. 7,262,760, application Ser. No. 11/119,719, filed May 2, 2005 and which issued on Jan. 2, 2007 as U.S. Pat. No. 7,158,118, and Provisional Patent Application No. 61/077,238, filed on Jul. 1, 2008; each of which is incorporated herein by reference in its entirety. Also further details of a tracking system, which may be representative of the tracking systems 160, 110, may be found in in application Ser. No. 12/424,090, filed on Apr. 15, 2009 Apr. 15, 2009.

Although only one trackable device is shown in FIG. 1B, the system 150 may include one or more additional trackable devices akin to the trackable device 104. Each of the additional trackable devices may move independently from one another and/or from the trackable device 104. Alternatively, some (e.g., not all) of the additional trackable devices 104 may move independently from one another and some (e.g., not all) of the additional trackable devices may move independently from the trackable device 104. Each of the trackable/tracked device 104 and the additional trackable/tracked devices may be configured to be hand held, or alternatively, may be disposed on/in (e.g., mounted to) a head, a foot, a robot, an animal or anything else that moves.

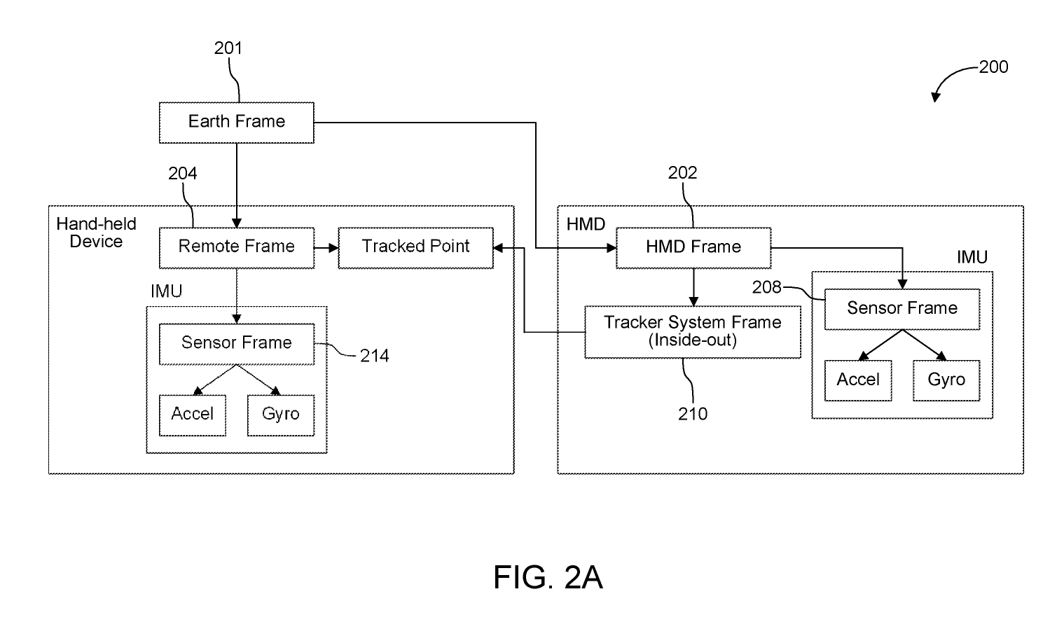

FIG. 2A is a block diagram illustrating various frames of reference (“frames”) that may be associated with the system 100. The various frames may include an Earth frame 201, a HMD frame 202, a HMD sensor frame 208, a tracking system frame 210, a remote frame 204 and a remote sensor frame 214. The HMD frame 202 may be associated with the HMD 102, and may correspond to (e.g., be aligned to, at a known offset from, etc.) to the tracked point of the HMD 102. The HMD sensor frame 208 may be associated with the IMU 108, and may correspond to (e.g., be aligned to, at a known offset from, etc.) the IMU 108. The tracking system frame 210 may be associated with the tracking system 110, and may correspond to (e.g., be aligned to, at a known offset from, etc.) the tracking system 210. The remote frame 204 may be associated with the remote 104, and may correspond to (e.g., be aligned to, at a known offset from, etc.) the tracking point on the remote 104. The remote sensor frame 214 may be associated with the IMU 114, and may correspond to (e.g., be aligned to, at a known offset from, etc.) the IMU 114. The terms “sensor frame”, “inertial frame” and “body frame” are synonymous industry terms, and may be used interchangeably herein.

FIG. 2B is a block diagram illustrating various frames that may be associated with the system 150. The various frames may include an Earth frame 201, a HMD frame 252, a HMD sensor frame 258, a tracking system frame 260, a remote frame 254 and a remote sensor frame 264. The HMD frame 252 may be associated with the HMD 152, and may correspond to (e.g., be aligned to, at a known offset from, etc.) to the tracked point of the HMD 152. The HMD sensor frame 258 may be associated with the IMU 158, and may correspond to (e.g., be aligned to, at a known offset from, etc.) the IMU 158. The tracking system frame 260 may be associated with the tracking system 160, and may correspond to (e.g., be aligned to, at a known offset from, etc.) the tracking system 260. The remote frame 254 may be associated with the remote 104, and may correspond to (e.g., be aligned to, at a known offset from, etc.) the tracking point on the remote 104. The remote sensor frame 264 may be associated with the IMU 114, and may correspond to (e.g., be aligned to, at a known offset from, etc.) the IMU 114.

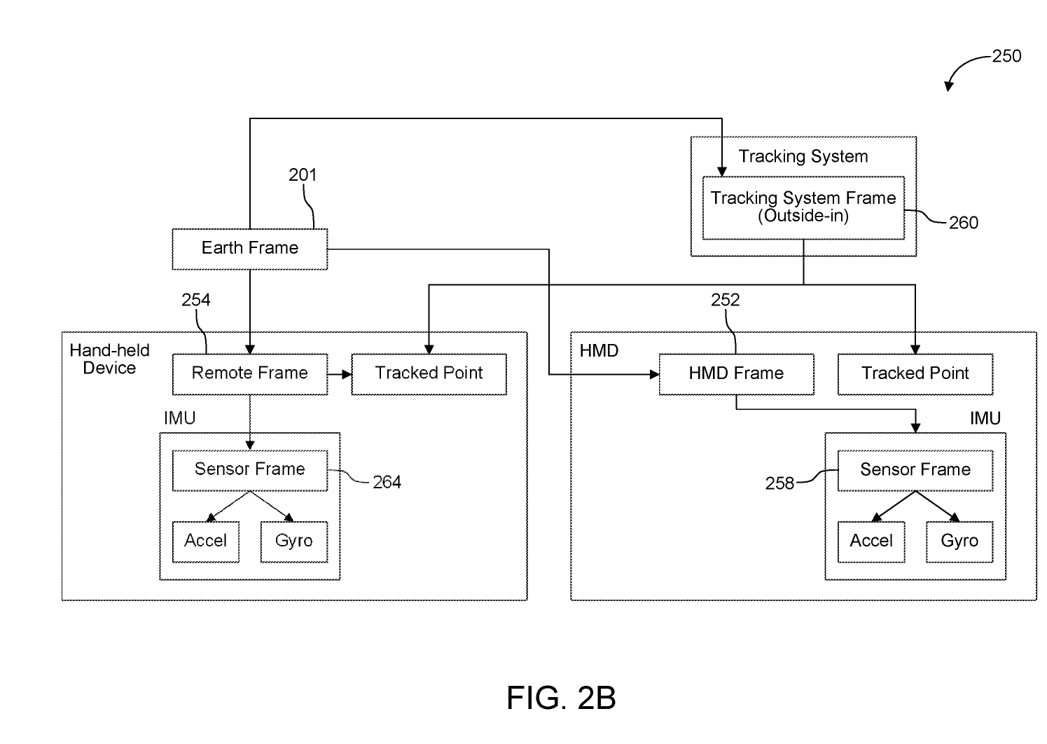

Referring now to FIG. 3, a block diagram illustrating a representative procedure 300 directed to frame aligning of linear position and linear acceleration of a tracked device is shown. For simplicity of exposition, the disclosure that follows in connection with FIG. 3 is described with respect to the system 100 of FIG. 1A. The representative procedure 300 may be carried out in other architectures as well.

A processor in communication with the tracking system 110 and the remote 104 (e.g., the processor 106) may obtain a linear acceleration of the remote 104 in a frame associated to the remote 104 (302). The processor may also obtain a linear position of the remote 104 in a frame associated to tracking system 110 (304). The processor may transform the linear acceleration and the linear position into first and second (i.e., respective) position signals, each of which may define change in position in its corresponding frame (306).

Transforming the linear acceleration and the linear position into the first and second position signals may be carried out as follows, in no particular order. The processor may filter the linear acceleration and the linear position using a first filter that retains signal variation. This first filter may be, for example, a high pass filter (DC-block filter) configured to remove linear acceleration due to gravity from linear acceleration due to motion. Applying the first filter to the linear acceleration results in a filtered linear acceleration that retains the linear acceleration due to motion. Applying the first filter to the linear position may cause the second position signal that ultimately results from the transformation to be comparable, e.g., maintain the same frequency response, group delay and other properties, to the first position signal that ultimately results from the transformation. Any of the filtered linear position and the filtered linear acceleration may be further processed by the processor, e.g., to remove extraneous, outlier and/or undesired components thereof.

The processor may perform a time integration of the filtered linear acceleration and may filter a signal resulting therefrom using a second filter that retains signal variation so as to obtain a velocity signal. The second filter may be a high pass filter (DC-block filter) configured to avoid accumulation of integration errors, and may have the same or different frequency response as the first filter. Applying the second filter to the signal resulting from the integration of the filtered linear acceleration may allow for the rejection of integration errors in the resultant linear velocity. The processor may filter the filtered linear position using the second filter so as to obtain an intermediate position signal. Applying the second filter to the second position signal may cause the second position signal that ultimately results from the transformation to be comparable, e.g., maintain the same frequency response, group delay and other properties, to the first position signal that ultimately results from the transformation. Any of the velocity signal and the intermediate position signal may be further processed by the processor, e.g., to remove extraneous, outlier and/or undesired components thereof.

The processor may perform a time integration of the velocity signal and may filter a signal resulting therefrom using a third filter that retains signal variation so as to obtain the first linear position signal. The third filter may be a high pass filter (DC-block filter) configured to avoid accumulation of integration errors, and may have the same or different frequency response as the first and/or second filters. Applying the third filter to the signal resulting from the integration of the velocity signal may allow for the rejection of integration errors in the resultant first position signal. The processor may filter the intermediate position signal using the third filter so as to obtain the second position signal. Applying the third filter to the intermediate linear position signal may cause the second position signal obtained therefrom to be comparable, e.g., maintain the same frequency response, group delay and other properties, to the first position signal that ultimately results from the transformation. Any of the first and second position signals may be further processed by the processor, e.g., to remove extraneous, outlier and/or undesired components thereof.

After the transformations, the processor may determine a transform for aligning the frames associated to the remote 104 and tracking system 110 based on the first and second position signals (308). The processor may determine the transform, at least in part, by any of solving a Wahba's problem formulation for the first and second position signals; using a linear fitting model problem formulation for the first and second position signals; using a non-linear optimization search for the first and second position signals, and using any search that finds a “best” rotation that minimizes a cost function representing an error between the first and second position signals. The processor may align the linear position with the linear acceleration using the determined transform (310). Using this transform, the signal frames may be aligned by either transforming the linear position into the frame of the linear acceleration, or by transforming the linear acceleration into the frame of the linear position. Alternatively, the transform may be decomposed and parts of the transform may be applied to both, for example, to use the heading from the linear position frame, but use the tilt (pitch and roll) from the linear acceleration frame.

The determined transform (310) may be applied to align the linear position and any available signals from the IMU, including any of the IMU's angular velocity, angular acceleration, angular position, gravity, linear acceleration, linear velocity, linear position or magnetometer. Once aligned, the processor may combine the linear position with the angular position, for example, using the determined transform (310), thus creating a six degree-of-freedom tracking device.

The procedure 300 may be carried out in a first alternative, as follows. The processor may obtain the linear acceleration (302) and the linear position (304) as above. The processor may transform the linear acceleration and the linear position into first and second (i.e., respective) acceleration signals, each of which may define change in acceleration in its corresponding frame (306).

Transforming the linear acceleration and the linear position into the first and second acceleration signals may be carried out as follows. The processor may filter the linear acceleration and the linear position using a first filter that retains signal variation. The first filter may be a low pass filter, for example. Applying the first filter to the linear acceleration may cause the first acceleration signal that ultimately results from the transformation to be comparable, e.g., maintain the same frequency response, group delay and other properties, to the second acceleration signal that ultimately results from the transformation. Applying the first filter to the linear position may cause the second acceleration signal that ultimately results from the transformation to be comparable, e.g., maintain the same frequency response, group delay and other properties, to the first acceleration signal that ultimately results from the transformation. Any of the filtered linear position and the filtered linear acceleration may be further processed by the processor, e.g., to remove extraneous, outlier and/or undesired components thereof.

The processor may perform a time derivative of the filtered linear position and may filter a signal resulting therefrom using a second filter that retains signal variation so as to obtain a velocity signal. The second filter may be a low pass filter, and may have the same or different frequency response as the first filter. Applying the second filter to the signal resulting from the derivative of the filtered linear position may cause the velocity signal to reject errors resulting from performing the derivative, e.g. filter out high-frequency noise that is amplified by the time derivative. The processor may also filter the filtered linear acceleration using the second filter so as to obtain an intermediate acceleration signal. Applying the second filter to the filtered linear acceleration may further cause the first acceleration signal to be comparable, e.g., maintain the same frequency response, group delay and other properties, to the second acceleration signal that ultimately results from the transformation. Any of the intermediate acceleration signal and the velocity signal may be further processed by the processor, e.g., to remove extraneous, outlier and/or undesired components thereof.

The processor may perform a time derivative of the velocity signal and may filter a signal resulting therefrom using a third filter that retains signal variation so as to obtain the second acceleration signal. The third filter may be a low pass filter, and may have the same or different frequency response as the first and/or second filters. Applying the third filter to the signal resulting from the performing the derivative of the velocity signal may cause the second acceleration signal to reject errors resulting from performing the derivative, e.g., filter out high-frequency noise that is amplified by the time derivative. The processor may also filter the intermediate acceleration signal using the third filter so as to obtain the first acceleration signal. Applying the third filter to the intermediate acceleration signal may further cause the first acceleration signal obtained therefrom to be comparable, e.g., maintain the same frequency response, group delay and other properties, to the second acceleration signal that ultimately results from the transformation. Any of the first and second acceleration signal may be further processed by the processor, e.g., to remove extraneous, outlier and/or undesired components thereof.

After transformation, the processor may determine a transform for aligning the frames associated to the remote 104 and to the tracking system 110 based on the first and second acceleration signals (308). The processor may determine the transform, at least in part, by any of solving a Wahba's problem formulation for the first and second acceleration signals; using a linear fitting model problem formulation for the first and second acceleration signals; using a non-linear optimization search for the first and second acceleration signals, and using any search that finds a “best” rotation that minimizes a cost function representing an error between the first and second acceleration signals.

Using the transform, the signal frames may be aligned by either transforming the linear position into the frame of the linear acceleration, or by transforming the linear acceleration into the frame of the linear position. Alternatively, the transform may be decomposed and parts of the transform may be applied to both, for example, to use the heading from the linear position frame, but use the tilt (pitch and roll) from the linear acceleration frame.

The determined transform (310) may be applied to align the linear position and any available signals from the IMU, including any of the IMU's angular velocity, angular acceleration, angular position, gravity, linear acceleration, linear velocity, linear position or magnetometer. Once aligned, the processor may combine the linear position with the angular position, for example, using the determined transform (310), thus creating a six degree-of-freedom tracking device.

The procedure 300 may be carried out in a second alternative, as follows. The processor may obtain the linear acceleration (302) and the linear position (304) as above. The processor may transform the linear acceleration and the linear position into first and second (i.e., respective) velocity signals, each of which may define change in acceleration in its corresponding frame (306). Transformation of the linear acceleration and the linear position into first and second velocity signals may be carried out as follows.

The processor may filter the linear acceleration and the linear position using a first filter that retains signal variation. The first filter may be a band pass filter, for example. Applying the first filter to the linear acceleration results in a filtered linear acceleration that retains the linear acceleration due to motion. Applying the first filter to the linear position may cause the second velocity signal that ultimately results from the transformation to be comparable, e.g., maintain the same frequency response, group delay and other properties, to the first velocity signal that ultimately results from the transformation. Any of the filtered linear position and the filtered linear acceleration may be further processed by the processor, e.g., to remove extraneous, outlier and/or undesired components thereof.

The processor may perform a time integration of the filtered linear acceleration and may filter a signal resulting therefrom using a second filter that retains signal variation so as to obtain the first velocity signal. The second filter may be a band pass filter, and may have a different frequency response than the first filter. Applying the second filter to the signal resulting from the integration of the filtered linear acceleration may allow for the rejection of integration errors in the resultant first velocity signal. The processor may perform a time derivative of the filtered linear position and may filter a signal resulting therefrom using the second filter so as to obtain the second velocity signal. Applying the second filter to the signal resulting from the derivative of the filtered linear position may cause the second velocity signal to reject errors resulting from performing the derivative, e.g., filter out high-frequency noise that is amplified by the time derivative. Any of the first and second velocity signal may be further processed by the processor, e.g., to remove extraneous, outlier and/or undesired components thereof.

After transformation, the processor may determine a transform for aligning the frame associated to the remote 104 and to the tracking system 110 based on the first and second velocity signals (308). The processor may determine the transform, at least in part, by any of solving a Wahba's problem formulation for the first and second velocity signals; using a linear fitting model problem formulation for the first and second velocity signals; using a non-linear optimization search for the first and second velocity signals, and using any search that finds a “best” rotation that minimizes a cost function representing an error between the first and second velocity signals.

Using this transform, the signal frames may be aligned by either transforming the linear position into the frame of the linear acceleration, or by transforming the linear acceleration into the frame of the linear position. Alternatively, the transform may be decomposed and parts of the transform may be applied to both, for example, to use the heading from the linear position frame, but use the tilt (pitch and roll) from the linear acceleration frame. The processor, for example, may align the linear position with an angular position using the determined transform (310). The determined transform (310) may be applied to align the linear position and any available signals from the IMU, including any of the IMU's angular velocity, angular acceleration, angular position, gravity, linear acceleration, linear velocity, linear position or magnetometer. Once aligned, the processor may combine the linear position with the angular position, for example, using the determined transform (310), thus creating a six degree-of-freedom tracking device.

The representative procedure 300 may be carried out repeatedly to continually or continuously track alignment between the frame associated to the remote 104 and the frame associated to tracking system 110. The transform determined in any embodiment of the representative procedure 300 may be any of a rotation transformation, a linear transformation, a yaw only rotation transformation, a scale transformation, a skew transformation, and a non-linearity transformation.

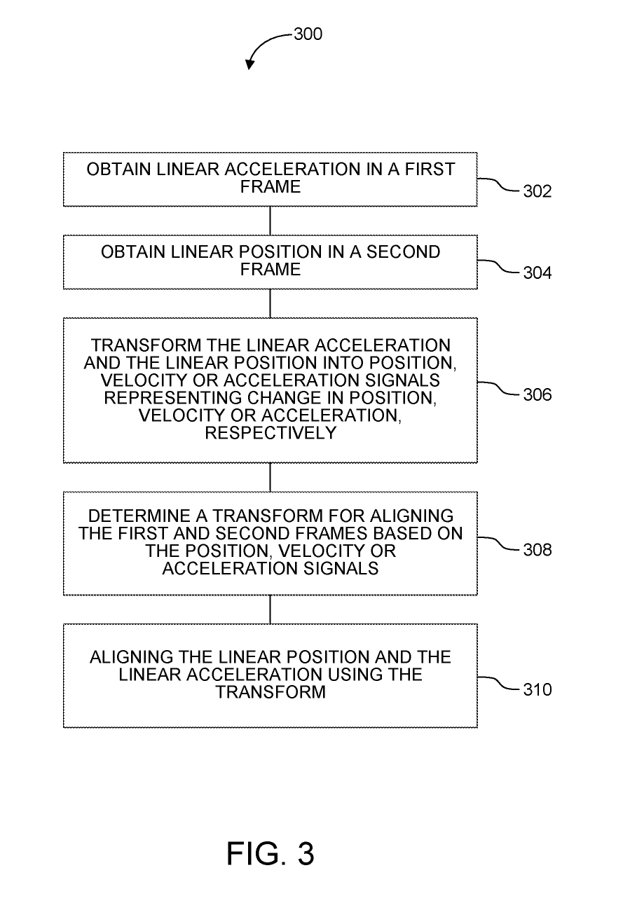

FIG. 4 is a block diagram illustrating a representative procedure 400 directed to frame aligning of linear position and angular position of a tracked device. The representative procedure 400 of FIG. 4 is similar to the representative procedure 300 of FIG. 3, except that angular position is used instead of linear acceleration, and hence may be carried out in the same way as the representative procedure 300 of FIG. 3.

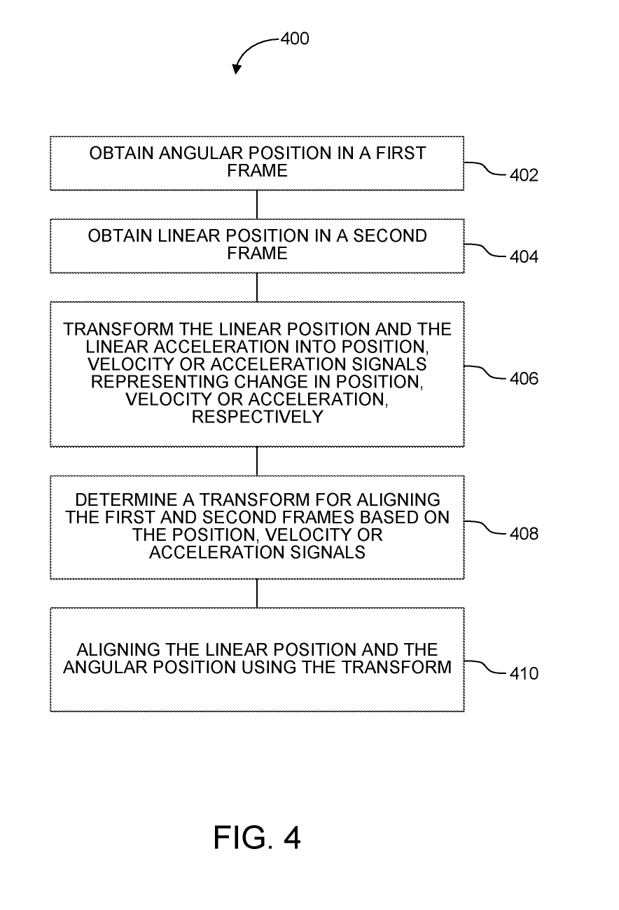

FIG. 5 illustrates a representative usage scenario for the representative system 100 of FIG. 1 using the corresponding reference frames of FIG. 2. In the example shown in FIG. 5, the HMD frame 202, the HMD sensor frame 208 and the tracking system frame 210 are assumed to be aligned to one another at a single location, and the remote frame 204 and remote sensor frame 214 are assumed are assumed to be aligned to one each other at a single location.

In accordance with the example shown, the remote 104 may have an acceleration, a^{rB}, in the remote sensor frame 214; and may have an angular position relative to the Earth frame 201 of quaternion, q^{r}. The tracking system 110 may have an angular position relative to the Earth frame 201 of quaternion q^{c}, and may have a linear acceleration, a^{cB}, in the HMD sensor frame 208. The acceleration, a^{rB}, and the quaternion, q^{r} may be provided or derived from measurements provided from the remote IMU 114. The quaternion, q^{c}, and linear acceleration, a^{cB}, may be provided or derived from measurements provided from the HMD IMU 108. The linear position of the remote 104 in the HMD frame 202 may be p^{cB}. The linear position, p^{cB}, may be provided or derived from measurements provided from the tracking system 110. The linear position, p^{cB}, may be a relative displacement between the tracking system 110 and the tracked point on the remote 104.

Ideally, the position, velocity and acceleration of the remote 104 in the Earth (or other common) frame 201 measured by or derived from the remote IMU 114 should be equal to corresponding values measured or derived by HMD IMU 108 and the tracking system 110, such that:

p^{iU}=p^{cU}

v^{iU}=v^{cU}

a^{iU}=a^{cU}

p^{iU} and p^{cU}, and v^{cU}, a^{iU} and a^{cU} may be the relative linear position, velocity and acceleration of the remote 104 in the Earth (or other common) frame 201 based on the remote IMU data and the combination of the tracking-system measurement data and HMD IMU data, respectively. The acceleration of the remote 104, a^{iU}, does not include the accelerations due to gravity.

Due to the frame misalignment, measurement noise and other sensor errors (like scale, skew, offset, rotation, and non-linearity), the above equations generally do not hold in practice. A transformation (e.g., an appropriate or best transformation) that can align the remote frame 204 and the tracking system frame 210 may be used to resolve the frame alignment (e.g., rotation) differences between the relative linear positions, p^{iU} and p^{cU}, the relative linear velocities, v^{iU} and v^{cU}, and/or the relative linear accelerations a^{iU} and a^{cU}. The transformation may be any of a rotation transformation, a linear transformation, a yaw only rotation transformation, a scale transformation, a skew transformation, and a non-linearity transformation. The transformation may include other transforms as well. The transformation may be determined in any of a position domain, velocity domain and an acceleration domain. Such determination, for example, may be based on any of a solving a Wahba problem formulation, using a linear fitting model problem formulation using a non-linear optimization search, and any search that finds a “best” rotation that minimizes a cost function representing the error between the two measurements.

Representative Wahba Problem Formulation

To align the remote IMU data and the combination of the tracking-system measurement data and the HMD IMU data using a rotation transformation, in the position domain, a Wahba's problem formulation that seeks to minimize the cost function may be:

J(R)=Σₖ₌₁^{N} ∥R×pₖ^{iU}−pₖ^{iU}∥²

where rotation matrix, R, may be used to align pₖ^{iU} and pₖ^{cU} of N samples based on the remote IMU data and the combination of the tracking-system measurement data and the HMD IMU data. In the velocity and the acceleration domains, the cost functions may be:

J(R)=Σₖ₌₁^{N}∥R\textcircled{×}vₖ^{cU}∥²

and

J(R)=Σₖ₌₁^{N}∥R\textcircled{×}aₖ^{iU}−aₖ^{cU}∥², respectively

Representative Linear Fitting Model Formulation

In the position domain, the linear fitting model formulation may be:

pₖ^{cU}=A×pₖ^{iU}+vₖ

where A may be a linear transformation (matrix) to convert pₖ^{iU} to pₖ^{cU} (e.g., as close as possible) in terms of least square errors; and vₖ may be the fitting error. The least square solution may be:

$$est ( A ) = arg {min}_{A} {\sum }_{k = 1}^{N} {‖ {p}_{k}^{cU} - A \times {p}_{k}^{iU} ‖}^{2}$$

The linear transformation (matrix), A, may be found by a recursive least square method. The linear transformation (matrix), A, may be decomposed into a product of a rotation matrix, R, a scale matrix, D, and a skew matrix, S:

A=R×D×S

The rotation matrix, R, may be used to correct, compensate or otherwise adjust for misalignment of orientation of the remote 104. In the velocity and acceleration domains, the linear fitting model formulation may be:

$$est ( A ) = arg {min}_{A} {\sum }_{k = 1}^{N} {‖ {v}_{k}^{cU} - A \times {v}_{k}^{iU} ‖}^{2} and$$

$$est ( A ) = arg {min}_{A} {\sum }_{k = 1}^{N} {‖ {a}_{k}^{cU} - A \times {a}_{k}^{iU} ‖}^{2} , respectively .$$

Comparing the linear model fitting formulation with Wahba problem formulation, the former may factor into account not only the frame misalignment errors but also scale and skew errors between the remote IMU data and the combination of the tracking-system measurement data and HMD IMU data. When the scale matrix is close to an identity matrix and the off-diagonal elements in the skew matrix are close to zero, the computed rotation matrix, R, may be more credible. This may provide a good indicator for assessing the reliability of the computed rotation matrix, R. Both formulations have computational efficient methods to solve.

As noted, the transformation (rotation) may be determined in any of the position domain, velocity domain and the acceleration domain. However, to derive the corresponding values from sensor measurements might introduce different error profiles. This may make a difference when selecting which of the domains to find an appropriate (e.g. the most reliable) rotation for correcting the frame misalignment or otherwise aligning the frames.

Representative Position, Velocity and Acceleration for Different Systems

Relative linear positions, velocities and accelerations of the remote 104 for three different systems are described. The first system may be the system 100 (or other inside-out tracking system in which a tracking system is disposed or otherwise combined with on an HMD). The second system may be the system 150 (or other outside-in tracking system, such that the tracking system is fixed in the external environment where the tracked object is within its line of sight and field of view). The third system is a special form of the system 100 (or other inside-out tracking system in which a tracking system is disposed or otherwise combined with an HMD IMU). In this special form of system 100 the linear acceleration a^{cB} is not available from the HMD IMU 108.

Representative Inside-Out Tracking System

As shown in FIGS. 1A and 5, the tracking system 110 moves along with head motion. The linear position, velocity and acceleration of the remote 104 relative to the tracking system 110 may depend on head motion.

Remote Position p^{iU} and p^{cU}

The position change of the remote 104 based on the remote IMU data and the combination of the tracking-system measurement data and HMD IMU data, respectively, may be:

p^{iU}=∫∫q^{r}\textcircled{×}a^{rB}dtdt

^{cU}=q^{c}\textcircled{×}p^{cB}−q0^{cB}−∫∫q^{c}\textcircled{×}a^{cB}dtdt

where p0^{cB} and q0^{c} may be an initial linear and angular position, which may be constant; and where the operator, \textcircled{×}, may be a quaternion rotation operation. In an embodiment, a discrete leaky integrator may be used instead of a continuous integral.

Remote Velocity v^{iU} and v^{cU}

The velocities of the remote 104 derived from p^{cB} and computed by using a^{rB} and a^{cB} may be:

$${v}^{iU} = \int {q}^{r} ⊗ {a}^{rB} dt$$

$${v}^{cU} = \frac{d ( {q}^{c} ⊗ {p}^{cB} )}{dt} - q {0}^{c} ⊗ v {0}^{cB} - \int {q}^{c} ⊗ {a}^{cB} dt$$

where v0^{cB} may be an initial velocity in the tracking system frame 210, q0^{c} may be an initial angular position of the tracking system frame 210. Both of the initial velocity, v0^{cB}, and the initial angular position, q0^{c}, may be constant. In an embodiment, a discrete leaky integrator may be instead of a continuous integral and/or a discrete derivative may be used instead of the continuous derivative.

Remote Acceleration a^{iU} and a^{cU}

The accelerations of the remote 104 determined based on the remote IMU data and HMD IMU data, respectively, and derived from p^{cB} may be:

$${a}^{iU} = {qr}^{r} ⊗ {a}^{rB}$$

$${a}^{cU} = \frac{{d}^{2} ( {q}^{c} ⊗ {p}^{cB} )}{{dt}^{2}} - {q}^{c} ⊗ {a}^{cB}$$

Representative Outside-In Tracking System

As shown in FIG. 1B, the tracking system 110 may be stationary, which may mean that a^{cB} becomes zero and q^{c} is constant.

Remote Position p^{iU} and p^{cU}

The position change of the remote 104 based on the remote IMU data and the combination of the tracking-system measurement data and HMD IMU data, respectively, may be:

p^{iU}=∫∫q^{r}\textcircled{×}a^{rB}dtdt

p^{cU}=q^{c}\textcircled{×}(p^{cB}−p0^{cB})

where p0^{cB} may be the initial position determined based on the tracking-system measurement data; and where the operator, \textcircled{×}, may be a quaternion rotation operation.

Remote Velocity v^{iU} and v^{cU}

The velocities of the remote 104 may be:

$${v}^{iU} = \int {q}^{r} ⊗ {a}^{rB} dt$$

$${v}^{cU} = \frac{d ( {q}^{c} ⊗ {p}^{cB} )}{dt} - {q}^{c} ⊗ v {0}^{cB}$$

Remote Acceleration a^{iU} and a^{cU}

The accelerations of the remote 104 may be:

$${a}^{iU} = {q}^{r} ⊗ {a}^{rB}$$

$${a}^{cU} = \frac{{d}^{2} ( {q}^{c} ⊗ {p}^{cB} )}{{dt}^{2}}$$

Representative Inside-Out Tracking System Without Linear Acceleration a^{cB}

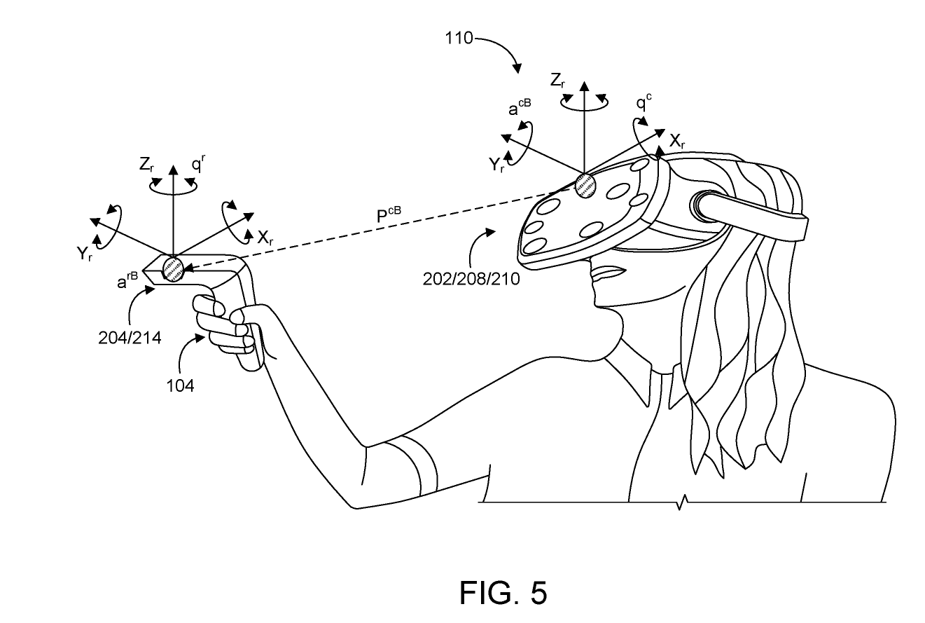

For the special case of the system 100 shown in FIG. 6, tracking a head position change without a linear acceleration a^{cB} being provided or derived from measurements provided from the HMD IMU 108, as shown in FIG. 6. In this case, the relative linear position change may be compensated to align well with the computed position change by using an acceleration, a^{rB}, provided or derived from measurements provided from the remote IMU 114.

To compensate the linear position change during head rotation, the origin of the tracking system frame 210 may be set to a head rotation center, e.g., a position approximately at the user's neck, such as shown in FIG. 6 The tracking system 110 center in this new frame is denoted as h0^{cB}. The tracking-system linear position measurement p^{cB}, which is in the tracking system frame 210 with the origin at the center of the tracking system 110, may p^{cB}+h0^{cB}. Using such compensation, the problem formulation may be as disclosed below.

Remote Position p^{iU} and p^{cU}

For head with rotation-only motion, the position change of the remote 104 based on the remote IMU data and the combination of the tracking-system measurement data and the HMD IMU data without the linear acceleration a^{cB}, respectively, may be:

p^{iU}=∫∫q^{r}\textcircled{×}a^{rB}dtdt

p^{cU}=q^{c}\textcircled{×}(p^{cB}+h0^{cB})−q0^{c}\textcircled{×}p0^{cB}

where p0^{cB} and q0^{c} may be the initial linear and angular position, respectively; where h0^{cB} may be the tracking system position in the coordinates with the origin at the head rotation center.

Remote Velocity v^{iU} and v^{cU}

For head with rotation-only motion, the velocities may be:

$${v}^{iU} = \int {q}^{r} ⊗ {a}^{rB} dt$$

$${v}^{cU} = \frac{d ( {q}^{c} ⊗ ( {p}^{cB} + p {0}^{cB} ) )}{dt} - q {0}^{c} ⊗ v {0}^{cB}$$

Remote Acceleration a^{iU} and a^{cU}

For head with rotation-only motion, the accelerations may be:

$${a}^{iU} = {q}^{r} ⊗ {a}^{rB}$$

$${a}^{cU} = \frac{{d}^{2} ( {q}^{c} ⊗ ( {p}^{cB} + p {0}^{cB} ) )}{{dt}^{2}}$$

Table 1 below lists the relative linear positions, velocities and accelerations of the remote 104 for the three different systems.

TABLE 1

| | | | Inside-out System |
|---|---|---|---|
| | Inside-out System | Outside-in System | without a^{cB} |
| Position p^{iU} | ∫∫ q^{r} [symbol] a^{rB} dtdt | ∫∫ q^{r} [symbol] a^{rB} dtdt | ∫∫ q^{r} [symbol] a^{rB} dtdt |
| Position p^{cU} | q^{c} [symbol] p^{cB} − q0^{c} [symbol] p0^{cB} − ∫∫ q^{c} [symbol] a^{cB} dtdt | q^{c} [symbol] (p^{cB} − p0^{cB}) | q^{c} [symbol] (p^{cB} + h0^{cB}) − q0^{c} [symbol] p0^{cB} |
| Velocity v^{iU} | ∫ q^{r} [symbol] a^{rB} dt | ∫ q^{r} [symbol] a^{rB} dt | ∫ q^{r} [symbol] a^{rB} dt |
| Velocity v^{cU} | $\frac{d ( {q}^{c} ⊗ {p}^{cB} )}{dt} - q {0}^{c} ⊗ v {0}^{cB} - \\ \int {q}^{c} ⊗ {a}^{cB} dt$ | $\frac{d ( {q}^{c} ⊗ {p}^{cB} )}{dt} - {q}^{c} ⊗ v {0}^{cB}$ | $\frac{d ( {q}^{c} ⊗ ( {p}^{cB} + p {0}^{cB} ) )}{dt} - q {0}^{c} ⊗ v {0}^{cB}$ |
| Acceleration a^{iU} | q^{r} [symbol] a^{rB} | q^{r} [symbol] a^{rB} | q^{r} [symbol] a^{rB} |
| Acceleration a^{cU} | $\frac{{d}^{2} ( {q}^{c} ⊗ {p}^{cB} )}{{dt}^{2}} - {q}^{c} ⊗ {a}^{cB}$ | $\frac{{d}^{2} ( {q}^{c} ⊗ {p}^{cB} )}{{dt}^{2}}$ | $\frac{{d}^{2} ( {q}^{c} ⊗ ( {p}^{cB} + p {0}^{cB} ) )}{{dt}^{2}}$ |

Among the domains of acceleration, velocity and position, a transformation (e.g., a best transformation) to align the remote frame 204 and tracking system frame 210 may be found. The noise level may be a consideration. Since a derivative of linear position may (e.g., may significantly) amplify embedded noise, acceleration and velocity derived therefrom may be much noisier. Additionally, or alternatively, tracking system measurement glitches and occlusion may cause discontinuity(ies) in the linear position measurements, which may exacerbate derivative errors. In the position domain, double integration upon the acceleration may have a smooth position curve. However, any non-zero bias or DC component in the acceleration may cause the integration to diverge quickly and/or undesirably. An appropriate filter, such as disclosed herein, may be used to alleviate the divergence. Consequently, problem formulating for position p^{iU} and p^{cU} may be more attractive than for the velocity and/or acceleration domains.

Unlike theory, the position, velocity and acceleration of the remote 104 in the Earth frame 201 based on the remote IMU data and the tracking-system measurement data and/or the HMD IMU data may very different. These differences may be caused by many errors (e.g., instead of only the frame misalignment). Four main error sources are identified. These error sources may be circumvented or filtered out so that the differences are mainly due of frame misalignment.

First, the IMU and tracking system measurements might not be time aligned. Second, the tracking system tracking center and the IMU location might not be the same. In other words, the IMU and tracking system might be measuring different spots. Third, integration of the acceleration generally (e.g., always) diverges due to a gravity residual remaining in the linear acceleration. Forth, the tracking system measurements may be very noisy and may be different from inertial measurements due to occlusion or glitches. Embodiments below may be used overcome such errors and, in turn, to determine a reliable rotation matrix to align the remote frame 204 and tracking system frame 210.

Representative Measurement Time Alignment

The initial and tracking system measurements might not be, and often times are not, time aligned. They may be aligned in various ways. For example, the linear acceleration provided by the tracking system 110 is the double derivatives of its linear position measurements. A time delay between the inertial acceleration and the tracking system acceleration may be determined by finding a maximum of a cross-correlation between their norms. Given two signals x and its delayed one y, the time delay between them is

$$est ( n ) = arg {max}_{n} ( x * y ) [ n ]$$

(x*y)[n] is the cross-correlation.

Representative Measurement Location Alignment

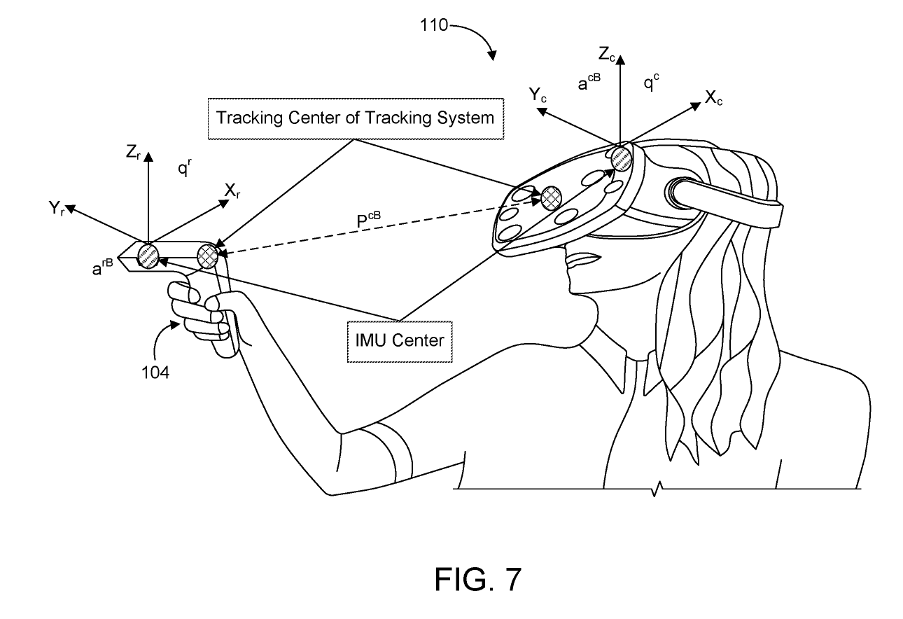

The tracking system 110 may track markers on the remote. The tracking center might not be, and often times is not, at the same as the location of the remote IMU 104, where the acceleration may be measured. An example of which is shown in FIG. 8.

Consequently, the acceleration measured by the remote IMU 104 and the linear position measured by the tracking system 110 are at different spots. For the tracking system 110 and the remote IMU 104 to measure the same spot, the rigid body equation may be applied to convert the linear acceleration provided from the remote IMU to that of the tracking center of the tracking system. The rigid body equation is

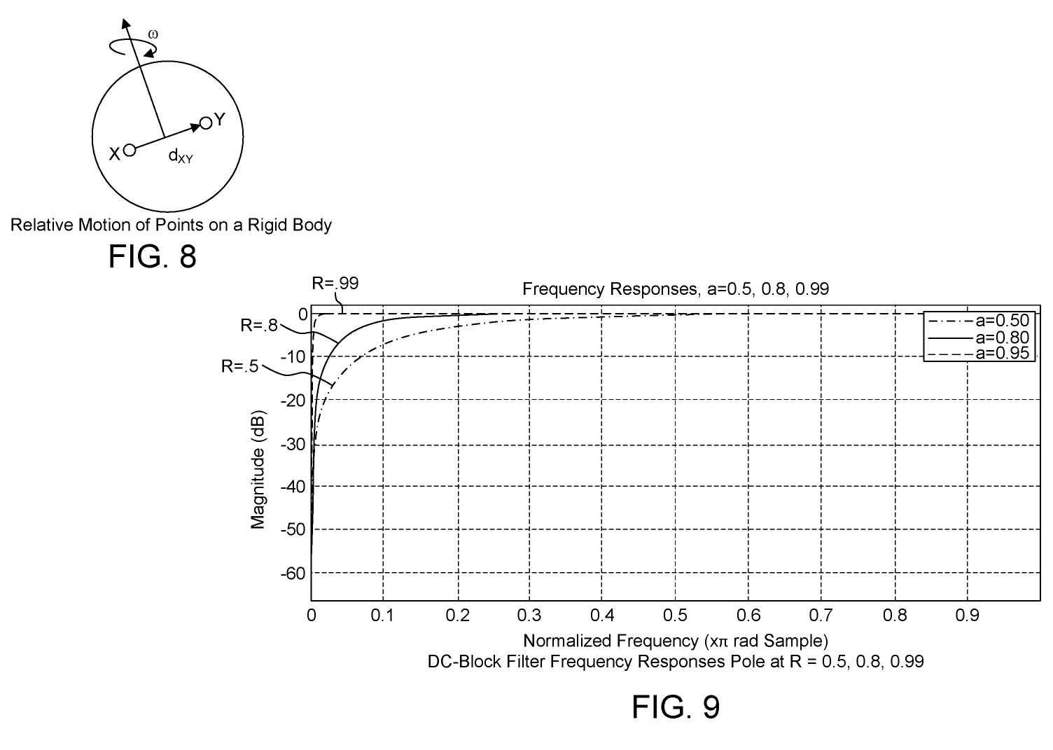

\vec{a}_{y}=\vec{a}ₓ+cross(\vec{\dot{ω}}, \vec{d}_{xy})+cross(\vec{ω},cross(\vec{ω}, \vec{d}_{xy}))

where \vec{a}ₓ and \vec{a}_{y} are the linear acceleration at location X and Y; \vec{d}_{xy} is the linear displacement between X and Y; \vec{ω} and \vec{\dot{ω}} are the angular velocity and acceleration of the rigid body object. An example of the application of the rigid body equation is shown in FIG. 9. The linear displacement, \vec{d}_{xy}, may be obtained by directly measuring the real device.

The displacement between the tracking center on the remote and the remote IMU may be estimated by a nonlinear least square fitting of the measurements of \vec{a}ₓ, \vec{a}_{y}, \vec{ω} and \vec{\dot{ω}} as well. \vec{a}ₓ and \vec{ω} are measured by the IMU. \vec{\dot{ω}} is the derivative of \vec{ω}. \vec{a}_{y} is the double derivative of the linear position p^{cB} as the tracking system is still.

$$est ( {\vec{d}}_{xy} ) = arg {min}_{{d}_{xy}} {\sum }_{k = 1}^{N} {‖ {\vec{a}}_{y} - ( {\vec{a}}_{x} + cross ( \vec{\dot{ω}} , {\vec{d}}_{xy} ) + cross ( \vec{ω} , cross ( ω , {d}_{xy} ) ) ) ‖}^{2}$$

After est(\vec{d}_{xy}) is obtained, the acceleration of remote IMU may be converted to the acceleration at the tracking center through the rigid body equation.

Representative DC-Block Filter

To overcome the integration divergence, a DC-block filter (high pass filter) may be applied before and after each integration operation so that only signal variation remains. An example of a DC-block filter may be a recursive filter specified by a difference equation:

y(n)=[x(n)−x(n−1)]*(1+a)/2+a*y(n−1)

Its frequency responses, pole at R=0.5, 0.8, 0.99, may be as shown in FIG. 8.

A first linear position signal (FIG. 3, 306) may be determined using linear position variation from measurements provided by the remote IMU and the following function (e.g., a leaky integrator):

p^{iU}^{_}^{filt}=filt(∫(filt_{DCB}(∫filt_{DCB}(q^{r}\textcircled{×}a^{rB})dt))dt)

The same filter is applied upon the tracking system linear position measurements to determine a second linear position signal (FIG. 3, 306) as:

p^{cU}^{_}^{filt}=filt_{DCB}(filt_{DCB}(filt_{DCB}(p^{cU})))

Pursuant to the above, DC components in p^{cU} leak out and p^{cU} is regulated in the same way as obtaining p^{iU}^{_}^{filt}. This may be one way to bridge theoretical formulation and practical implementation. It makes it possible that the primary remaining differences between p^{cU}^{_}^{filt} and p^{iU}^{_}^{filt} are mainly due to the frame misalignment.

It is common that the integration operation and the high-pass (DC blocking) filter are both linear and time-invariant (LTI). One of the properties of LTI systems is that they are communitive across convolution. So when they are LTI, the system:

filt_{DCB}(∫(filt_{DCB}(∫filt_{DCB}(q^{r}\textcircled{×}a^{rB})dt))dt)

is equivalent to

filt_{DCB}(filt_{DCB}(filt_{DCB}(∫∫q^{r}\textcircled{×}a^{rB}dtdt)))

And since the convolution of two or more high-pass (dc-blocking) filters is also a high pass (dc-blocking) filter, then this is equivalent to:

filt_{DCB}(∫∫q^{r}\textcircled{×}a^{rB}dtdt)

Also, in theory the acceleration due to gravity must be removed from the measurement of the accelerometer before it is integrated to create velocity and position. However, the leaky integrator may remove gravity along with other error accumulations. After the dc-blocking filter has settled, the result of the leaky integrator may be the same whether gravity is removed or not. For faster settling, gravity may be removed by using the equation:

p^{iU}^{_}^{filt}=filt_{DCB}(∫(filt_{DCB}(∫filt_{DCB}(q^{r}\textcircled{×}a^{rB}−g)dt))dt)

where g is the acceleration due to gravity (e.g. the vector [0, 0, 9.8]).

Then, as a Wahba problem formulation, it is expected that

p^{cU}^{_}^{filt}=R×p^{iU}^{_}^{filt}+v

where R is the rotation matrix to align the remote frame with the head mounted camera frame; v is the noise (FIG. 3, 310).

Alternatively, as a least square fitting problem, it is expected that

p^{cU}^{_}^{fllt}=A×p^{iU}^{_}^{filt}+v

where A is the linear fitting model parameter. The rotation matrix can be found through matrix decomposition (FIG. 3, 310).

Representative Measurement Selection

The measurements do not always carry the information to align the remote IMU frame and the tracking system frame. This may occur, for example, when the remote is stationary, or when the hand held device is occluded from tracking system. In those situations, the computed rotation matrix might not be credible. One way to circumvent this issue may be to select proper measurements to feed into the algorithm(s). In an embodiment, measurements that satisfy the following conditions may be selected:

∥∥p^{cU}^{_}^{filt}∥−∥p^{iU}^{_}^{filt}∥∥<Threshold1

∥a^{cU}^{_}^{filt}∥>Threshold2

The Threshold1 and Threshold2 may be learned from the real data. The first condition may guarantee that a norm of the linear position cannot be too different. When their differences are mainly due to frame misalignment instead of others, their norm should be close. This condition may be used to reject (e.g., filter most bad) measurements, e.g., glitches. The second condition may make sure the remote is not stationary. Even for inside-out tracking system without linear acceleration of the HMD, the tracking system frame and the remote IMU frame may be aligned (e.g., well aligned) by selecting proper measurements to feed into the algorithm(s).

Representative Solutions to the Formulations

Wahba Solution

For the Wahba problem formulation, the solution can be found using a singular decomposition.

Step 1: Compute a matrix B as follows

B=Σₖ₌₁^{N}aₖpₖ^{cU}^{_}^{filt}(pₖ^{iU}^{_}^{filt})^{T}

where aₖ are the weights for the column vectors pₖ^{cU}^{_}^{filt} and pₖ^{iU}^{_}^{filt} at time k; (·)^{T} is the vector transpose.

Step 2: Obtain the singular value decomposition of BI

B=SVD^{T}

Step 3: The rotation matrix is:

R=SMD^{T}

where

M=diag([1 1 det(S)det(D)]), det(S)

is the determinant of the matrix S.

RLS Solution

Assume the measurement model is

zₖ=xₖA+vₖ

where A is a n×m matrix, xₖ is 1×n vectors, zₖ and vₖ are 1×m vectors. vₖ is the noise. The recursive least square solution for A at kth observation is

$${K}_{k} = \frac{{λ}^{- 1} {P}_{k - 1} {x}_{k}^{′}}{1 + {λ}^{- 1} {x}_{k} {P}_{k - 1} {x}_{k}^{′}}$$

$${P}_{k} = {λ}^{- 1} {P}_{k - 1} - {λ}^{- 1} {K}_{k} {x}_{k} {P}_{k - 1}$$

$${\hat{A}}_{k} = {\hat{A}}_{k - 1} - {P}_{k} {x}_{k}^{′} {x}_{k} {\hat{A}}_{k - 1} + {P}_{k} {x}_{k}^{′} {z}_{k}$$

where λ(0<λ<1) is the forget factor, Â₀ is initialized as zero vector or matrix; P₀ is initialized as a diagonal matrix δI.I is the identity matrix. δ is of a large positive value.

The fitting error can be recursively computed as

$${mse}_{k} = \frac{k - 1}{k} \times λ \times {mse}_{k - 1} + \frac{1}{k} \times ( {z}_{k} - {x}_{k} {\hat{A}}_{k - 1} ) {( {z}_{k} - {x}_{k} {\hat{A}}_{k - 1} )}^{′}$$

Note no matter A is a matrix or vector, this recursive solution always works.

Yaw-Only Correction

The above two solutions are to align the whole inertial frame with the camera frame. Most often, both the camera frame tilt and the remote frame tilt are stable and accurate. In some situations, e.g., the accelerometer saturation, the tilt of the camera frame could contain perceivable errors. In this situation, it is not desirable to align the remote frame tilt with the camera frame tilt. A yaw-only rotation can serve the purpose better. The yaw-only rotation matrix is to minimize the cost function

J(R)Σᵢ₌₁^{N}∥r^{Yaw}^{_}^{Only}×pₖ^{iU}(1:2)−pₖ^{cU}(1:2)∥²

in which only x-y coordinates factor into account. R^{Yaw}^{_}^{Only} is a rotation matrix of the form:

$$[ \begin{matrix}cos ( yaw ) & sin ( yaw ) \\ - sin ( yaw ) & cos ( yaw )\end{matrix} ]$$

and −180°<yaw≤180°.

A nonlinear programming optimization algorithm can be applied, such as:

fminseach(J(R(yaw)), yaw, −180°<yaw<180°).

Alternatively, a brutal-force direct search method can be used to find the best yaw

$$est ( yaw ) = {min}_{yaw = - {180}^{°} ; tol : {180}^{°}} J ( R ( yaw ) )$$

−180°:tol:180° is the sequence of −180°, −180°+tol, −180°+2×tol, −180°+3×tol, . . . , 180°−tol. tol is the error tolerance.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM″)) or non-volatile (e.g., Read-Only Memory (ROM″)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 25 U.S.C. § 112, ¶6 or means-plus-function claim format, and any claim without the terms “means for” is not so intended.

What is claimed is:

1. A method directed to frame aligning of linear position and linear acceleration of a tracked device, the method comprising:
obtaining a linear acceleration of the tracked device in a first frame associated to the tracked device;
obtaining a linear position of the tracked device in a second frame associated to a tracking device;
transforming the linear acceleration and the linear position into one of first and second position signals, first and second velocity signals and first and second acceleration signals defining change in position, change in velocity and change in acceleration, respectively;
determining a transform for aligning the first and second frames based on the one of first and second position signals, first and second velocity signals and first and second acceleration signals; and
aligning the linear position and linear acceleration using the transform.

2. The method of claim 1, wherein transforming the linear acceleration and the linear position into first and second position signals comprises:
filtering the linear acceleration and the linear position using a first filter that retains signal variation;
filtering the filtered linear position using a second filter that retains signal variation so as to obtain an intermediate position signal;
performing a time integration of the filtered linear acceleration and filtering a signal resulting therefrom using the second filter so as to obtain a velocity signal;
filtering the intermediate position signal using a third filter that retains signal variation so as to obtain the second position signal; and
performing a time integration of the velocity signal and filtering a signal resulting therefrom using the third filter so as to obtain the first position domain signal.

3. The method of claim 2, wherein any of the first, second and third filters is a high pass filter.

4. The method of claim 1, wherein transforming the linear acceleration and the linear position into first and second acceleration signals comprises:
filtering the linear acceleration and the linear position using a first filter that retains signal variation;
filtering the filtered linear acceleration using a second filter that retains signal variation so as to obtain an intermediate acceleration signal;
performing a time derivative of the filtered linear position and filtering a signal resulting therefrom using the second filter so as to obtain a velocity signal;
filtering the intermediate acceleration signal using a third filter that retains signal variation so as to obtain the first acceleration signal; and
performing a time derivative of the velocity signal and filtering a signal resulting therefrom using the third filter so as to obtain the second acceleration signal.

5. The method of claim 4, wherein any of the first, second and third filters is a low pass filter.

6. The method of claim 1, wherein transforming the linear acceleration and the linear position into first and second velocity signals comprises:
filtering the linear acceleration and the linear position using a first filter that retains signal variation;
performing a time integration of the filtered linear acceleration and filtering a signal resulting therefrom using a second filter that retains signal variation so as to obtain the first velocity signal; and
performing a time derivative of the filtered linear position and filtering a signal resulting therefrom using the second filter so as to obtain the second velocity signal.

7. The method of claim 6, wherein any of the first and second filters is a bandpass filter.

8. The method of claim 1, wherein the transform is any of a rotation transformation, a linear position transformation, a yaw only rotation transformation, a pitch and roll only transformation, a scale transformation, a skew transformation, a perspective projection transformation and a non-linearity transformation.

9. The method of claim 1, wherein determining the transform comprises any of:
solving a Wahba's problem formulation for the first and second position signals, the first and second velocity signals or the first and second acceleration signals;
using a linear fitting model problem formulation for the first and second position signals, the first and second velocity signals or the first and second acceleration signals;
using a non-linear optimization search for the first and second position signals, the first and second velocity signals or the first and second acceleration signals; and
using any search that finds a “best” rotation that minimizes a cost function representing an error between the first and second position signals, the first and second velocity signals or the first and second acceleration signals.

10. The method of claim 1, wherein each of the first frame and the second frame is any of an Earth frame, a user frame, a level frame and an arbitrary, short term common frame.

11. The method of claim 1, wherein both of the first and second frames are associated with a tracking center of the tracked device.

12. An apparatus comprising circuitry, including a processor and memory, configured to:
obtain a linear acceleration of the tracked device in a first frame associated to the tracked device;
obtain a linear position of the tracked device in a second frame associated to a tracking device;
transform the linear acceleration and the linear position into one of first and second position signals, first and second velocity signals and first and second acceleration signals defining change in position, change in velocity and change in acceleration, respectively;
determine a transform for aligning the first and second frames based on the one of first and second position signals, first and second velocity signals and first and second acceleration signals; and
align the linear position and linear acceleration using the transform.

13. The apparatus of claim 12, wherein the circuitry is configured to transform the linear acceleration and the linear position into first and second position signals, at least in part, by:
filtering the linear acceleration and the linear position using a first filter that retains signal variation;
filtering the filtered linear position using a second filter that retains signal variation so as to obtain an intermediate position signal;
performing a time integration of the filtered linear acceleration and filtering a signal resulting therefrom using the second filter so as to obtain a velocity signal;
filtering the intermediate position signal using a third filter that retains signal variation so as to obtain the second position signal; and
performing a time integration of the velocity signal and filtering a signal resulting therefrom using the third filter so as to obtain the first position domain signal.

14. The apparatus of claim 13, wherein any of the first, second and third filters is a high pass filter.

15. The apparatus of claim 12, wherein the circuitry is configured to transform the linear acceleration and the linear position into first and second acceleration signals, at least in part, by:
filtering the linear acceleration and the linear position using a first filter that retains signal variation;
filtering the filtered linear acceleration using a second filter that retains signal variation so as to obtain an intermediate acceleration signal;
performing a time derivative of the filtered linear position and filtering a signal resulting therefrom using the second filter so as to obtain a velocity signal;
filtering the intermediate acceleration signal using a third filter that retains signal variation so as to obtain the first acceleration signal; and
performing a time derivative of the velocity signal and filtering a signal resulting therefrom using the third filter so as to obtain the second acceleration signal.

16. The apparatus of claim 15, wherein any of the first, second and third filters is a low pass filter.

17. The apparatus of claim 12, wherein the circuitry is configured to transform the linear acceleration and the linear position into first and second velocity signals, at least in part, by:
filtering the linear acceleration and the linear position using a first filter that retains signal variation;
performing a time integration of the filtered linear acceleration and filtering a signal resulting therefrom using a second filter that retains signal variation so as to obtain the first velocity signal; and
performing a time derivative of the filtered linear position and filtering a signal resulting therefrom using the second filter so as to obtain the second velocity signal.

18. The apparatus of claim 17, wherein any of the first and second filters is a bandpass filter.

19. The apparatus of claim 12, wherein the transform is any of a rotation transformation, a linear position transformation, a yaw only rotation transformation, a pitch and roll only transformation, a scale transformation, a skew transformation, a perspective projection transformation and a non-linearity transformation.

20. The apparatus of claim 12, wherein the circuitry is configured to determine the transform, at least in part, by any of:
solving a Wahba's problem formulation for the first and second position signals, the first and second velocity signals or the first and second acceleration signals;
using a linear fitting model problem formulation for the first and second position signals, the first and second velocity signals or the first and second acceleration signals;
using a non-linear optimization search for the first and second position signals, the first and second velocity signals or the first and second acceleration signals; and
using any search that finds a “best” rotation that minimizes a cost function representing an error between the first and second position signals, the first and second velocity signals or the first and second acceleration signals.

21. The apparatus of claim 12, wherein each of the first frame and the second frame is any of an Earth frame, a user frame, a level frame and an arbitrary, short term common frame.

22. The apparatus of claim 12, wherein both of the first and second frames are associated with a tracking center of the tracked device.
